(19) United States
(12) Patent Application Publication
(10) Pub. No.: US 2008/0301143 A1
(43) Pub. Date: Dec. 4, 2008

(54) Automatic Update System and Method for Using a Meta Mib

(75) Inventor: Young Jin Kim, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/586,087

(22) PCT Filed: Jan. 14, 2005
(86) PCT No.: PCT/KR2005/000140

§ 371 Date: Aug. 20, 2008

(30) Foreign Application Priority Data
Jan. 15, 2004 (KR) 10-2004-0002982

(51) Int. Cl. G06F 17/30; G06F 15/16

(52) U.S. Cl. 707/10; 709/202; 707/E17.009

(57) ABSTRACT

The present invention generally relates to a system and method for automatically updating a MIB by using a meta MIB, and more particularly to a system and method for automatically updating a MIB by using a meta MIB comprising agent 100 for generating an OID named as MIB Info Last Change Time, storing it in the MIB and synchronizing the meta MIB by transmitting a Trap when MIB Info Last Change Time is changed; and NMS 200, in case a trap is inputted to the NMS, for reading an information in a meta MIB Info to SNMP Walk Operation, rewriting a meta MIB information of the agent based on the read information, storing the meta MIB information in the MIB and transmitting the meta MIB information to the agent. In accordance with the present invention, the drawback residing in the conventional structure is ameliorated by designing a basic structure of SMI in the form of meta MIB, SMI defining management information of MIB which is exchanged between the agent and the NMS. Therefore, the MIB of the agent can be automatically shared by the NMS via on-line, thereby improving an automation functionality of the network management, in spite of the trend to more complicated and advanced network.

### TECHNICAL FIELD

The present invention generally relates to a system and method for automatically updating a Management Information Base (MIB) by using a meta Management Information Base (MIB), and more particularly to a system and method for automatically updating a MIB by using an MIB focused on a maximization of network management functionality to allow a Network Management System (NMS) to achieve quick and precise network management based on MIB information provided from an agent via on-line.

### BACKGROUND ART

Generally, a Simple Network Management Protocol (SNMP) is a protocol for monitoring and generalizing a network management, a network device and operation thereof. Further, the SNMP allows management information on element of network to be inspected or changed logically by a remote user. Elements of a standard for managing a TCP/IP based network include: a Structure of Management Information (SMI) which describes a structure of management information of such SNMP; an MIB which is a definition of the management information; and the SNMP which is a communication protocol. The elements described above provide an operable structure and functionality for network management of Internet.

Moreover, the management information is exchanged between a NMS application and an agent of a Network Element (NE), thereby performing a model of SNMP network management structure.

In order to perform a process on a list of the management information between the NMS and the NE agent described above, the NMS and the NE agent share a MIB definition document of a SMI specification having the list of management information therein via off-line connection. In case the NE agent and the NMS fail to share the MIB, however, there occurs a drawback in that the NMS is prevented from performing network managing functionality associated with corresponding NE.

Therefore, it has become a great concern to maximize the network management functionality so that the quick and precise network management can be achieved at the NMS based on the MIB of the NE provided from the NE agent.

Further, the SNMP is proposed up to version 3 as a standardized protocol for network management of Internet, while a conventional network management structure using the SNMP includes typically one NMS and one or more NE agents.

The NE agent may be incorporated into various network elements, each of which is object of network management, and may make a direct access to information generated by the network elements and then sends the information to the NMS in a form suitable to the SNMP. The elements of the network management standard of Internet, such as SNMP, SMI, MIB, are basically defined in the form of Abstract Syntax Notation. 1 (ASN. 1), and encoding and decoding thereof are supposed to comply with Basic Encoding Rule (BER) which is adopted in ASN. 1.

Furthermore, the SNMP supports operations, such as Get-Request, GetNext-Request, Set-Request, Response, Trap and the like, thereby exchanging the network information between the NMS and each agent.

As described above, in the network management using the conventional SNMP as shown in FIG. 1, the MIB is the management information exchanged between the NE agent and the NMS by employing the SNMP. In this regard, the MIB may be used on the assumption that the syntax and context thereof should be shared between the NMS and the NE agent. The MIB is defined in compliance with the SMI syntax. This is so that the MIB defined with the SMI may be regarded as a set of management objects and each of the management objects has its unique identifier and feature.

The identifier of each management object has a unique value and the feature thereof is configured to comply with the syntax defined in the SMI. Further, the MIB sharing structure follows a general configuration employing the SNMP and the MIB has to be provided to the NMS and each of the NE agents, which has been performed accordingly by an operator.

However, the conventional way of updating the MIB in network to perform management thereof by using the SNMP has the drawback in that the MIB should be shared in advance. In case the MIB fails to be shared in advance, the NMS may not recognize which type of object information should be drawn from the NE agent. Further, it may not analyze the context thereof even though the specific information may be drawn.

### DISCLOSURE OF THE INVENTION

Therefore, the present invention is provided in order to address the problems described above. The object of the present invention is to provide a system and method for automatically updating a MIB by using the meta MIB, in which a correct MIB information of a corresponding agent can be synchronized thereto without determining whether the MID information is changed when the MIB information of the agent has been changed.

In accordance with one aspect of the present invention, there is provided a system for automatically updating a MIB of an agent by using a meta MIB in a Simple Network Management Protocol (SNMP) based network having the agent and a Network Management System (NMS) therein. The system comprises:

an agent for generating an OID named as MIB_Info_Last_Change_Time, storing it in the MIB and synchronizing the meta MIB by transmitting a Trap when MIB_Info_Last_Change_Time is changed; and

an NMS, in case a trap is inputted to the NMS, for reading an information in a meta MIB_Info to SNMP Walk Operation, rewriting a meta MIB information of the agent based on the read information, storing the meta MIB information in the MIB and transmitting the meta MIB information to the agent.

In accordance with another aspect of the present invention, there is provided a method for automatically updating a Management Information Base (MIB) information between a Network Management System (NMS) having a MIB and an agent having a MIB by using a meta MIB. The method comprises:

rendering the agent to check whether MIB_Info_Last_Change_Time is changed or not;

transmitting a trap generated by the agent to the NMS in case MIB_Info_Last_Change_Time is changed, while returning to the rendering step in case MIB_Info_Last_Change_Time is not changed;

making the NMS request a Walk Operation on the MIB information, followed by receiving the trap from the agent; and

letting the agent rewrite and store the MIB information through result of the Walk Operation.

### BRIEF DESCRIPTION OF THE DRAWINGS

FIG. 1 shows a conventional updating system using a MIB.

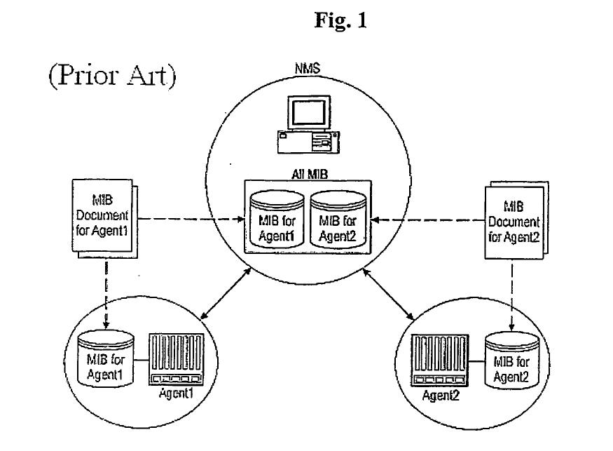

FIG. 2 illustrates an automatic updating system using a meta MIB in accordance with an embodiment of the present invention.

FIG. 3 depicts a functional block diagram showing the updating system using the meta MIB as shown in FIG. 1.

FIG. 4 illustrates a meta MIB shown in FIG. 1.

FIG. 5 shows a flow chart illustrating the automatic updating system using a meta MIB in accordance with an embodiment of the present invention.

### BEST MODE FOR CARRYING OUT THE INVENTION

Hereinafter, a system and method for automatically updating a MIB by using a meta MIB in accordance with one preferred embodiment of the present invention will be explained in detail.

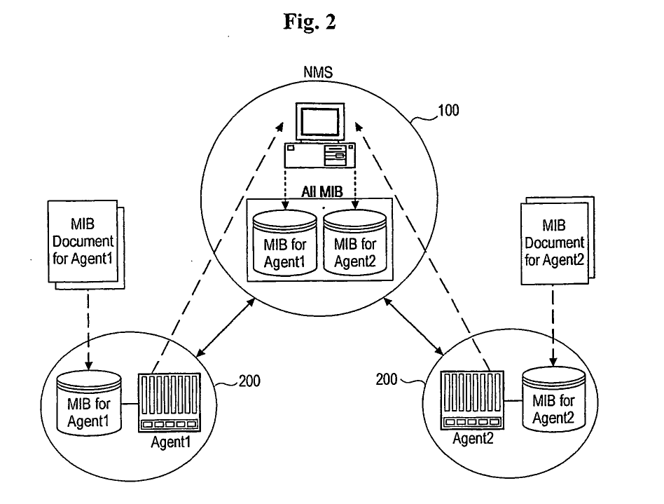

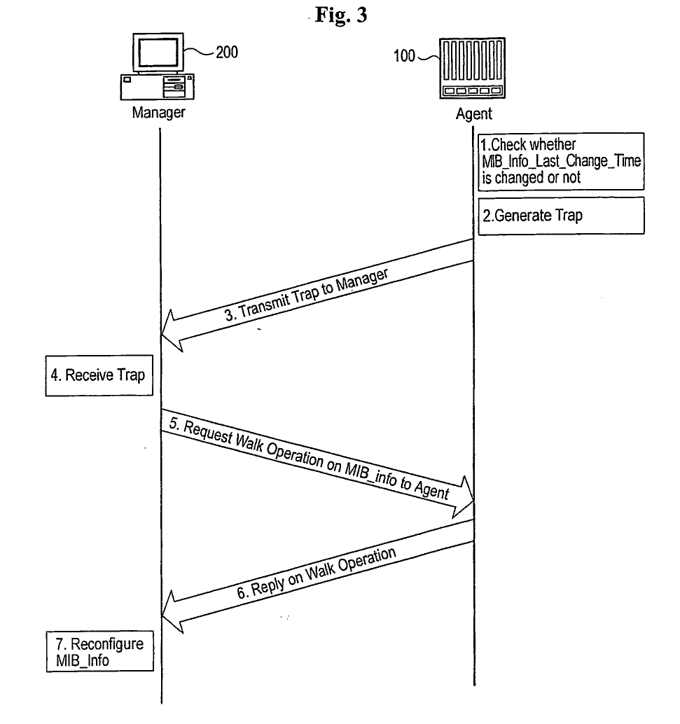

FIG. 2 shows an automatic updating system using a meta MIB in accordance with an embodiment of the present invention. FIG. 3 depicts a functional block diagram showing the updating system using the meta MIB. The automatic updating system using a meta MIB in accordance with an embodiment of the present invention includes agent 100 having a MIB and NMS 200 having a MIB.

Agent 100 generates an OID named as MIB_Info_Last_Change_Time, stores it in the MIB and synchronizes the meta MIB by transmitting a trap when MIB_Info Last_Change Time is changed.

Further, NMS 200, in case a trap is inputted to NMS 200, rewrites a meta MIB information of agent 100 based on SNMP Walk Operation result via a meta MIB_Info, stores the meta MIB information in the MIB and simultaneously transmits the meta MIB information to agent 100.

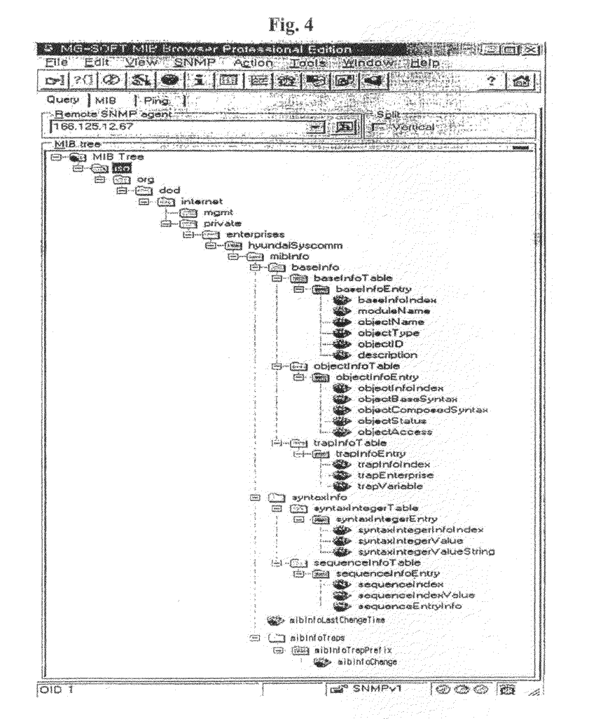

FIG. 4 shows the meta MIB structure, where Base_Info generates Trap_Info_Table and Object_Info_Table representing trap type object and Object_Type. It simultaneously generates Base_Info_Table, which reflects common features of the MIB objects.

The Base_Info_Table includes Base_Info_Entry having, as its subdirectory, Base_Info_Index for discriminating an index of table, Module_Name, Object_Name which is mapped with each management object shown in agent 100 MIB, Object_Type representing type of the management object mapped into a notification type, Object_ID mapped into management object OID of agent 100 MIB, and Description mapped into the MIB management object.

The Object_Info_Table includes Object_Info_Entry having Object_Info_Index for discriminating an index of table, Object_Base_Syntax having as a representation of MIB syntax an initial type of ASN. 1 such as Integer, Octet, String, Object Identifier and a configured type such as sequence, sequence off, Object_Composed_Syntax using display styling as an abstract syntax, Object_Status for mapping a type of agent 100 MIB object into mandatory, optional, obsolete, etc by using integer as an abstract, and Object_Access for mapping an access type of the MIB object into read, read/write, write, access denied by using integer as an abstract syntax.

The Trap_Info_Table includes Trap_Info_Entry having Trap_Info_Index for discriminating an index of table, Trap_Enterprise which is mapped into an enterprise value of a trap typed object of agent 100 MIB, and in case of notification type, mapped into NULL value, and Trap_Variable which is mapped into a changed value of the trap typed object of agent 100 MIB, and in case of notification type, mapped into target value.

Further, Syntax_Info generates Syntax_Integer_Table and Sequence_Info_Table;

The Syntax_Integer_Table includes Syntax_Info_Entry having Syntax_Integer_Info_Index with a table instance of agent 100 MIB, Syntax_Integer_Value, which is mapped into Sub_Type of integer of agent 100 MIB, and Syntax_Integer_Value_String, which maps Sub_Type expression of syntax integer of agent 100 MIB into string.

The Sequence_Info_Table includes Sequence_Info_Table having Sequence_Index for discriminating instance, Sequence_Index_Value which is mapped into table index of agent 100 MIB, the value being equal to a table index value of agent 100 MIB in the Base_Info_Index, and Sequence-Entry Info which is mapped into entry instance of agent 100 MIB, the value being equal to an entry instance value of agent 100 MIB in the Base_Info_Index.

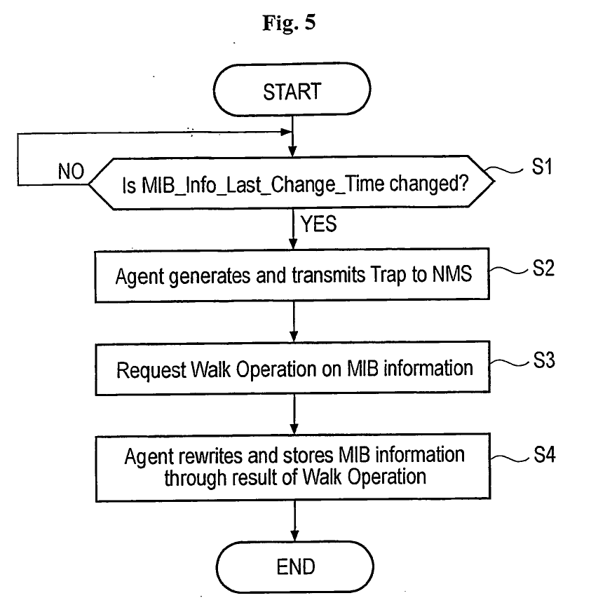

Next, an automatic updating method by using the meta MIB having the above-described structure will be illustrated with reference to FIG. 5.

First, agent 100 checks whether MIB_Info_Last_Change_Time is changed or not (S1).

While returning to step 1 (S1), in case MIB_Info_Last_Change_Time is not changed at step 1 (S1), agent 100 generates a trap and then transmits the trap to NMS 200 in case MIB_Info_Last_Change_Time is changed (S2). In other words, an OID named as MIB_Info_Last_Change_Time is generated and the trap is generated when MIB_Info_Last_Change_Time is changed.

Further, NMS 200 requests a Walk Operation on the MIB information, followed by receiving the trap from agent 100 (S3).

Subsequently, agent 100 rewrites and stores the MIB information through result of the Walk Operation (S4).

In the above, the present invention is explained in detail with reference to some particular embodiments. However, the present invention is not necessarily limited to those embodiments and could be varied within the scope thereof.

### INDUSTRIAL APPLICABILITY

As described above, in accordance with the automatic updating system and method by using the meta MIB, the drawback residing in the conventional structure is ameliorated by designing a basic structure of SMI in the form of meta MIB, SMI defining management information of MIB which is exchanged between the agent and the NMS. Therefore, the MIB of the agent can be automatically shared by the NMS via on-line, thereby improving an automation functionality of the network management, in spite of the trend to more complicated and advanced network.

1. A system for automatically updating a MIB of an agent by using a meta MIB in a Simple Network Management Protocol (SNMP) based network having the agent and a Network Management System (NMS) therein, the system comprising:
an agent for generating an OID named as MIB_Info_Last_Change_Time, storing it in the MIB and synchronizing the meta MIB by transmitting a Trap when MIB_Info_Last_Change Time is changed; and
an NMS, in case a trap is inputted to the NMS, for reading an information in a meta MIB_Info to SNMP Walk Operation, rewriting a meta MIB information of the agent based on the read information, storing the meta MIB information in the MIB and transmitting the meta MIB information to the agent.

2. A method for automatically updating a Management Information Base (MIB) information between a Network Management System (NMS) having a MIB and an agent having a MIB by using a meta MIB, the method comprising the steps of:
rendering the agent to check whether MIB_Info Last_Change_Time is changed or not;
transmitting a trap generated by the agent to the NMS in case MIB_Info_Last_Change Time is changed, while returning to the rendering step in case MIB_Info_Last_Change_Time is not changed;
making the NMS request a Walk Operation on the MIB information, followed by receiving the trap from the agent; and
letting the agent rewrite and store the MIB information through result of the Walk Operation.
